(19) United States
(12) Patent Application Publication
(10) Pub. No.: US 2008/0188250 A1
(43) Pub. Date: Aug. 7, 2008

(54) DELIVERING A RADIO PHONE SHORT MESSAGING SERVICE MESSAGE FORMAT WITHIN AN APPLICATION LAYER INTERNET PROTOCOL MESSAGE

(75) Inventors: Meenal Agarwal, Middletown, NJ (US); Suryaprakash Mareddy, Laurence Harbor, NJ (US)

Correspondence Address: UTSTARCOM, INC., 3800 GOLF ROAD, SUITE 220, ROLLING MEADOWS, IL, 60008, US

(73) Assignee: UTSTARCOM, INC., Alameda, CA (US)

(21) Appl. No.: 11/671,175

(22) Filed: Feb. 5, 2007

(51) Int. Cl. H04Q 7/20

(52) U.S. Cl. 455/466

(57) ABSTRACT

A method and apparatus wirelessly transmits messages from a first messaging service such as the Short Messaging Service (SMS) on a on a second messaging service such as a channel established by the Session Initiation Protocol (SIP). An original text message is encoded into a Short Messaging Service format of the first messaging service to produce a first encoded message. The first encoded message is encoded into a Session Initiation Protocol format of the second messaging service to produce a second encoded message, transmitted on a radio protocol. The second encoded message is received and decoded to produce the first encoded message. The first encoded message can be delivered to a server and decoded to produce the original text message.

### BACKGROUND OF THE INVENTIONS

1. Technical Field

The present inventions relate to messaging services and, more particularly, relate to providing a messaging service message format within another message format.

2. Description of the Related Art

The Short Messaging Service is a service available on digital mobile phones that permits the sending of short messages between mobile phones, other handheld devices and even landline phones. The Short Messaging Service (SMS) is also used for delivering message waiting indication MWI and other indications like email indication, fax indication to user equipment. This requires in SMS message format, a header present in the beginning of SMS body. The indication whether a header is present in SMS body, is present in another parameter called the transport protocol user data header indicator TP-UDHI parameter in a Transport protocol data unit (TPDU).

SMS is used for delivering a message waiting indication MWI to a phone such as a GSM phone. In GSM, both the GSM mobile application protocol (MAP) and radio interface protocol relay the short message transport layer SM_TL PDUs as it is for SMS service.

The problem is that in a wireless local area network there is no mobile application protocol.

### SUMMARY OF THE INVENTIONS

An object of the present inventions is to provide a first messaging service on a second messaging service where encoding an original text message into a Short Messaging Service SMS format of the first messaging service produces a first encoded message, encoding the first encoded message into a Session Initiation Protocol (SIP) format of the second messaging service to produces a second encoded message, then the second encoded message is transmitted on a radio protocol, where upon receiving the second encoded message on the radio protocol, the second encoded message is decoded to produce the first encoded message, then the first encoded message is delivered to a server, and the first encoded message is decoded to produce the original text message.

A further object of the present inventions is to transmit encoded messages with a Short Messaging Service SMS encoder, a Session Initiation Protocol SIP encoder, and a transceiver.

Another further object of the present inventions is to receive encoded messages with a transceiver gateway and a server, where the transceiver comprises a Session Initiation Protocol SIP decoder capable of decoding an SIP encoded message and producing a SMS encoded message, and the server comprises a Short Message decoder capable of decoding a SMS encoded message and producing an original text message.

The details of the preferred embodiments and these and other objects and features of the inventions will be more readily understood from the following detailed description when read in conjunction with the accompanying drawings wherein:

### BRIEF DESCRIPTION OF THE DRAWINGS

FIG. 1 illustrates a schematic block diagram of communications equipment for transport of messages between a phone and a server according to the present inventions;

FIG. 2 illustrates a flow diagram of exemplary call flow for presence of reporting to a service center that a sent message was originated within the communications equipment of the present inventions; and

FIG. 3 illustrates a flow diagram of exemplary call flow for presence of reporting that a sent message was terminated or received within the communications equipment of the present inventions.

### DETAILED DESCRIPTION OF THE PREFERRED EMBODIMENTS

We propose the solution of adopting the SMS transport protocol data unit TPDU relay method used in GSM, in SIP. For short message service, instead of sending the SMS text in a SIP MESSAGE body, we propose to place the SMS_SUBMIT TPDU and SMS_DELIVER TPDU in SIP MESSAGE body. This is encapsulation of the SMS TPDU in the SIP MESSAGE message.

Thus, a SIP message extension provides short message service in a next generation network using a scheme including all information elements in the SM_TL (SMS Transport Layer) PDUs (Protocol Data Units) in the SIP message body.

This has following advantages
1. The exchange of all information elements, not just few, is accomplished between the user equipment and the call server. This way SMS can be used for delivering other indications like voicemail, email and fax in Next Generation Networks (NGN).
2. A one time change in call server software is needed to support SMS service. Softswitch software need not modify for vendor specific or country specific use of reserved bits in a protocol data unit (PDU) or additional information elements.
3. Network architecture is more flexible. The softswitch does not read the PDU and transports it as it is. This gives us network architecture flexibility for using 3^{rd} party switches. 3^{rd} party switches just need to support sending PDU in message body instead of supporting additional headers for each parameter in PDU.
4. Advantage in terms of future upgrades. If reserved bits in IE of PDU are further used for additional services, softswitch need not change to accommodate this behavior. Only the end unit handset needs to be upgraded to interpret these additional bits.

The Session Initiation Protocol (SIP) is a protocol for setup and teardown of internet protocol (IP) based communication sessions. The Session Initiation Protocol (SIP) is defined in RFC 3261 published by the Internet Engineering Task Force (IETF). The SIP protocol accomplishes the setup and teardown of sessions by passing messages among servers and client agents. SIP is widely used for sessions of IP voice services. The SIP protocol uses many kinds of messages such as INVITE, REGISTER, OK, and REFER.

The SIP protocol also contains an instant messaging message defined in RFC 3428 published by the Internet Engineering Task Force (IETF). The instant messaging message is a MESSAGE message. This MESSAGE method is an extension to SIP; it inherits all the request routing and security features of that protocol. MESSAGE requests carry the content in the form of MIME body parts. MESSAGE requests may be sent in context of a dialog initiated by other SIP requests. The body of the SIP MESSAGE is the message itself. For example, I am saying “hello” to you, the body of SIP MESSAGE is “hello.” This MESSAGE method is being used for SMS also where body of SIP message is the short message text.

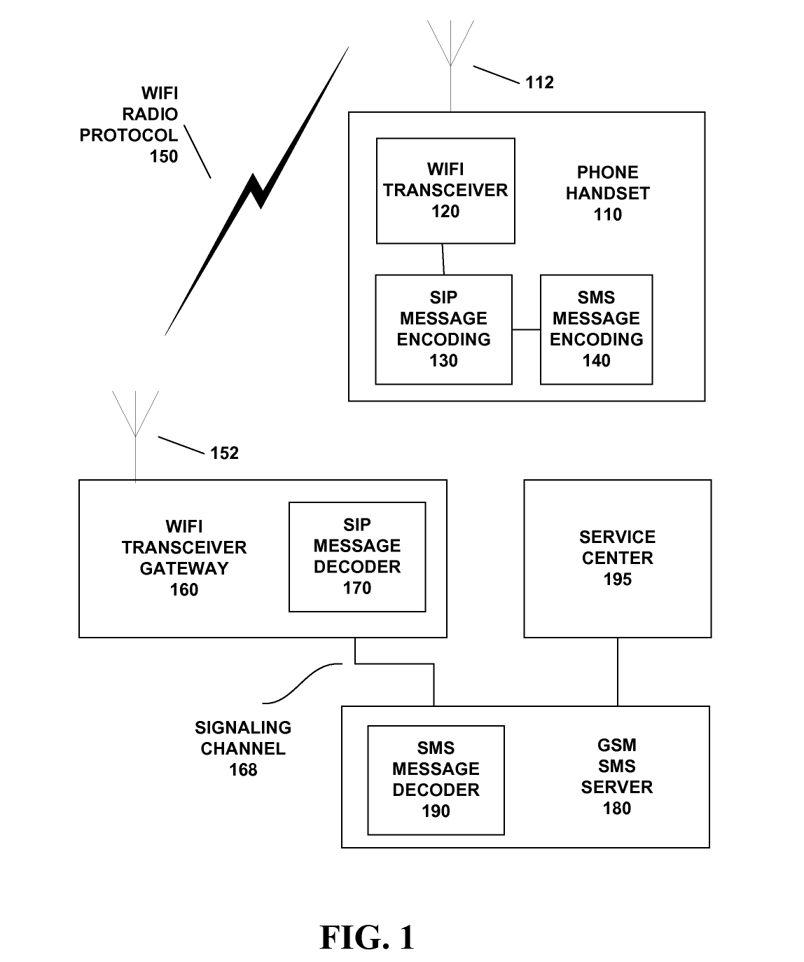

FIG. 1 shows the communications equipment for transport of messages between a phone handset 110 and a server 180. The server 180 is preferably a Global System for Mobile Communications GSM Short Messaging Service SMS server. A user of the phone handset 110 creates a text message which is encoded by an SMS Message Encoder 140. The encoded message may include information elements such as Short Messaging Service SMS transport layer protocol data units. The preferable transport protocol data units (TPDUs) are SMS_SUBMIT and SMS_DELIVER. These protocol data units PDU are defined by the Global System for Mobil Communications standard GSM 03.40 according to the European Telecommunications Standards Institute ETSI. The encoded message is then encoded into a Session Initiation Protocol SIP format by a SIP Message Encoder 130. The Session Initiation Protocol SIP is defined by Requests for Comments 3261 as published by The Internet Society. The preferable methods for encoding the message into SIP format may be the SIP MESSAGE method as defined by the Session Initiation Protocol Extension for Instant Messaging Request for Comments RFC 3428 published by The Internet Society. RFC 3428 is essentially an extension to the original Session Initiation Protocol SIP Request for Comments RFC 3261. Essentially SMS protocol data units such as SMS_SUBMIT and SMS_DELIVER are included in the body of the SIP message. The advantage of including SMS commands in the body of the SIP message is that it provides network flexibility. For example, if future upgrades include new bits of protocol data units (PDU), only the phone 110 needs to be upgraded because the softswitch need not read the PDU but merely transports it.

The SIP message is transported via antennas 112 and 152 by a transceiver 120 on a radio protocol 150 to a transceiver gateway 160. The radio protocol 150 is preferably a Wireless Fidelity (WiFi) protocol as defined by the WiFi Alliance. According to the WiFi Alliance, the term ‘WiFi’ is a generic term that refers to any wireless network. The transceiver 120 and the transceiver gateway 160 are preferably WiFi transceivers. This provides a seamless exchange of all information elements between both transceivers 120 and 160. The information elements may include internet protocol (IP) packets and indications for voicemail, email and fax. The protocol packets may be reassembled in the transceiver gateway 160 using a Session Initiation Protocol SIP. The SIP message is then decoded by a Session Initiation Protocol decoder 170 producing the SMS message.

The SMS message is then transported over a signaling channel 168 to a GSM SMS server 180. The signaling channel 168 is preferably an Internet protocol (IP) but may be a Public Switched Telephone Network (PSTN). The SMS message is then decoded by an SMS message decoder 190 to produce the original text message. Subsequently, the server 180 may send a first independent message to a service center 195. Upon receiving an ok from the service center 195 that the original message was received, the server 180 may send a second independent message to the transceiver gateway 160 that the original message was received successfully.

The SMS message is encoded into a signaling message of an application later internet protocol (IP) message such as a SIP signaling message. The SMS message is encoded into a signaling message, not on a media transport path. The advantage of placement in a signaling message, rather than a media transport path, is that it reduces the negotiation time to setup a traffic path on a network. The amount of data sent is also minimized.

Besides the Session Initiation Protocol SIP format, the aplication layer internet protocol (IP) format can be a Media Gateway Control Protocol (MGCP) format (H.248) on a Media Gateway Controller (Megaco). It can also be the older H.323 format.

What is meant by a Short Messaging Service (SMS) might be expanded to include all Radio Phone Messaging Services and also cover Multimedia Messaging Service (MMS), except it that case the Multimedia Messaging Service (MMS) messages could not be sent in the signaling message of an application layer internet protocol (IP) message. This is because Multimedia Messaging Service (MMS) messages are large in byte size would not fit in the small signaling message. Implementing Multimedia Messaging Service (MMS) messages requires working to send outside of signaling message. Thus the advantages of placement in the signaling message would be lost. Using an existing signaling message reduces the negotiation time to setup a media traffic path on a network.

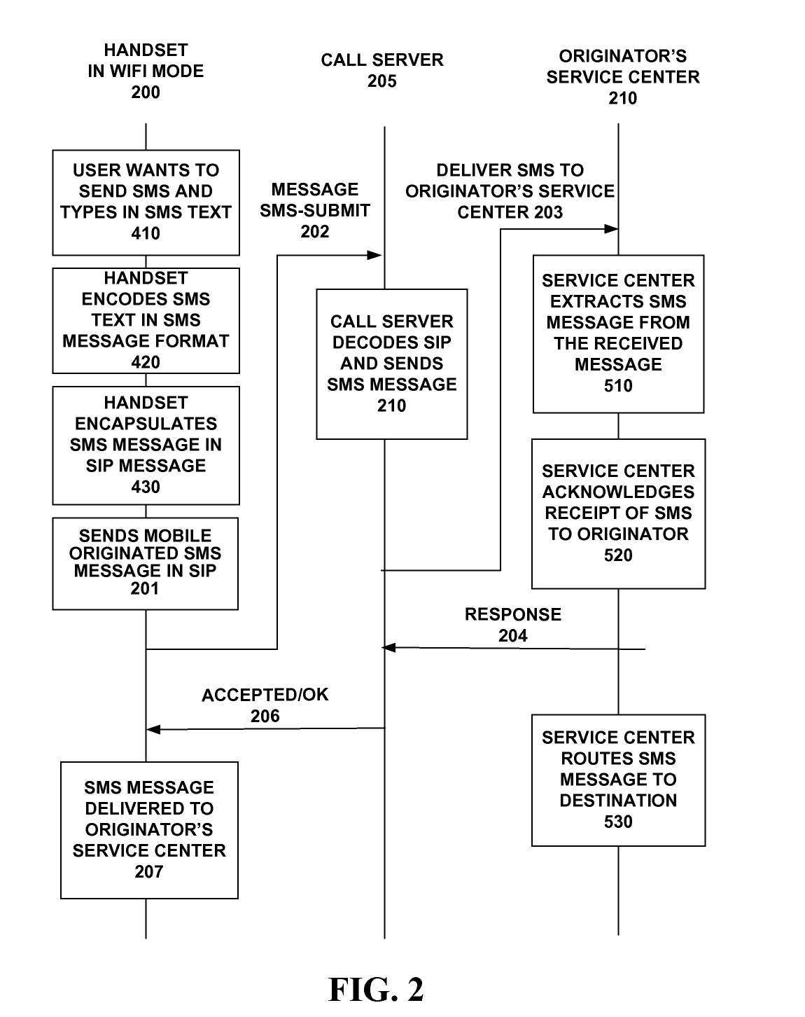

FIG. 2 shows the message flow of a text message, preferably encoded in short messaging service SMS format and contains a Short Messaging Service mobile station originated message SMS-MO. A mobile station originated message is from a handset 200 to a service center 210 via a call server 205. In this example, the handset is a WiFi handset 200. The encoded message may include information elements such as specified in Short Messaging Service SMS transport layer protocol data units. The preferable protocol data unit PDU is SMS_SUBMIT.

SMS origination starts at step 410 where user types in a SMS message on the WiFi handset 200. At step 420, the user encodes the SMS message in SMS message SMS_SUBMIT, the TPDU format. The WiFi handset 200 then encodes or encapsulates SMS_SUBMIT TDPU in the signaling message of an application layer SIP message in step 430. The WiFi handset 200 then sends 202 an encoded and encapsulated text message to a call server 205 at steps 201 and 202. In this example, this message is a SMS_SUBMIT in a signaling, e.g., control, message of SIP format at the application layer.

Upon receiving 202 the text message from the WiFi handset 200, the call server 205 decodes the SIP message and extracts SMS message at step 210. It then sends an independent message 203 containing the SMS message to the service center 210. Service center 210, upon receiving message 203 from the call server 205, extracts the SMS message SMS_SUBMIT from it at step 510. Service center 210 then acknowledges to the call server 205 of successful receipt of SMS message at step 520. Service center 210 then routes the SMS message to destination service center to be delivered to destination user at step 530.

Upon receiving an ok or accepted indication 204 from the service center 210, the call server 205 sends another independent message of ok or accepted 206 to the handset 200. The call server 205 can respond either with 206 accepted or ok. Accepted is possible because the SMS is being delivered to originator's service center and response is sent. It is not guaranteed that destination number received the SMS. Both replies should be taken as successful response. The SMS message SMS-MO is thus successfully delivered 207 to the originator's service center 210.

As shown by the steps, the originating and the terminating units (the handset and the service center), are the only nodes which are encoding and decoding SMS messages. Because the end point nodes encapsulate the encoded SMS message in another message format such as a SIP message, the call server does not need to decode or encode an SMS message format. The call server only encodes or decodes the SMS message from or to another message format such as a SIP message. This makes the intermediate call server transparent of the service.

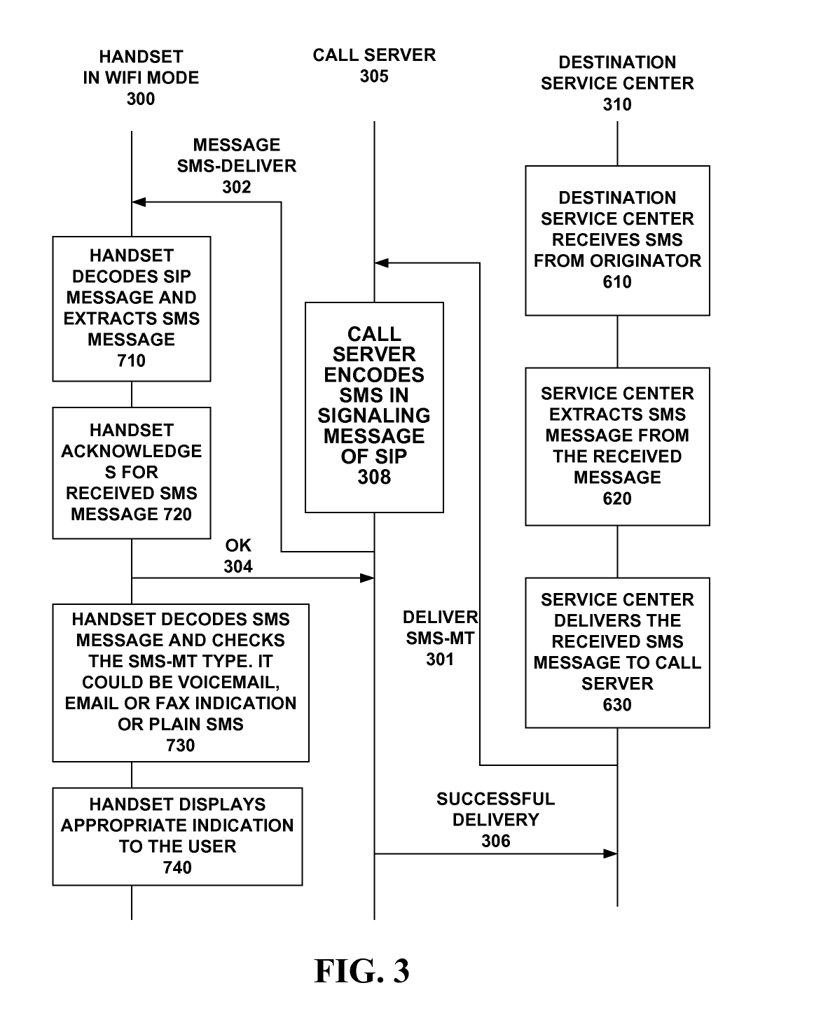

FIG. 3 shows the message flow of a text message, preferably encoded in a short messaging service SMS format, and contains a short messaging service mobile station terminated message SMS-MT. A mobile station terminated message is from a service center 310 to a handset 300 via a call server 305. In this example, the handset is a WiFi handset 300. The encoded message may include information elements such as Short Messaging Service SMS transport layer protocol data units. It may also contain within the PDU indication of received voice mail, email or fax indication. The preferable transport protocol data units TPDU is SMS_DELIVER.

The mobile termination SMS delivery starts from step 610 where a destination service center 310 receives the SMS message from originating service center. Service center 310 extracts the SMS message from the received message at step 620. Service center 310 then delivers the SMS message to the call server 305 at step 630.

Upon receiving 301 the message from the service center 310, the server 305 encapsulates or encodes the SMS message in the signaling message of the SIP at step 308. In this example, this message is encoded or encapsulated in a signaling, e.g., control, message of SIP at the application layer. The service center 310 then sends the message at 302 containing SMS message in SIP to the WiFi handset 300. The WiFi handset 300 decodes the received SIP message 301 and extracts SMS message at step 710. The WiFi handset 300 acknowledges and sends ok 304 to the call server 305 of successful receipt of SMS message at step 720. The WiFi handset 300 then decodes the received SMS message at step 730. At step 730, the WiFi handset 300 may also check the message content to see whether the SMS-MT is plain SMS or carries any indications like voicemail, email or fax indication. At step 740 depending upon the intent of SMS-MT, it displays appropriate indication to the user.

Upon receiving this acknowledgement message, the server 305 sends a message 306 to the service center 310 that the SMS text message 301 was successfully received by the WiFi handset 300. The SMS message SMS-MT is thus successfully delivered to the handset 300.

Again as shown by the aforementioned steps, the originating and the terminating units (the handset and the service center), are the only nodes which are encoding and decoding SMS messages. Because the end point nodes encapsulate the encoded SMS message in another message format such as a SIP message, the call server does not need to decode or encode an SMS message format. The call server only encodes or decodes the SMS message from or to another message format such as a SIP message. This makes the intermediate call server transparent of the service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. A method of providing a first messaging service on a second messaging service, the method comprising the steps of:
(a) encoding an original text message into a Short Messaging Service (SMS) format of the first messaging service to produce a first encoded message;
(b) encoding the first encoded message into an application layer Internet Protocol (IP) message format of the second messaging service to produce a second encoded message;
(c) transmitting the second encoded message on a radio protocol;
(d) receiving second encoded message on the radio protocol;
(e) decoding the second encoded message to produce the first encoded message;
(f) delivering the first encoded message to a server; and
(g) decoding the first encoded message to produce the original text message.

2. A method according to claim 1, wherein the radio protocol is a Wireless Local Area Network (LAN) protocol.

3. A method according to claim 2, wherein the Wireless Local Area Network (LAN) protocol comprises Wireless Fidelity (WiFi).

4. A method according to claim 1, wherein step (b) of encoding the first message into an application layer Internet Protocol (IP) messaging format further comprises the sub-step of (b1) encoding the first message as a signaling message of the application layer Internet Protocol (IP) messaging format to produce the second encoded message.

5. A method according to claim 4, wherein step (b) of encoding the first message into an application layer Internet Protocol (IP) messaging format further comprises the sub-step of (b1) encapsulating the first message in Session Initiation Protocol (SIP) format to produce the second encoded message.

6. A method according to claim 4, wherein the application layer Internet Protocol (IP) messaging format is chosen from the group consisting of (a) a Session Initiation Protocol (SIP) format, (b) a Media Gateway Control Protocol (MGCP) format (H.248), and (c) an H.323 format.

7. A method according to claim 1, wherein step (b) of encoding the first message into an application layer Internet Protocol (IP) messaging format further comprises the sub-step of (b1) encapsulating the first encoded message into the second encoded message.

8. A method according to claim 1, wherein said step (g) of decoding the first encoded message to produce the original text message comprises the steps of:
(g1) checking the original text message content to see whether it carries any indications; and
(g2) displaying an appropriate indication to the user.

9. A method according to claim 1, wherein step (g) further comprises the sub-steps of:
(g1) delivering a first message to a service center;
(g2) receiving an ok from service center that said first message was received; and
(g3) transmitting a second message to said first messaging service that said original message was received successfully.

10. A method according to claim 1, wherein steps (a) through (g) occur in reverse order.

11. A wireless apparatus for transmission of encoded messages comprising:
A Short Messaging Service (SMS) encoder for encoding an original text message into a Short Messaging Service (SMS) format to produce a first encoded message;
an application layer Internet Protocol (IP) messaging encoder operatively coupled to the Short Messaging Service (SMS) encoder to encode the first encoded message into an application layer Internet Protocol (IP) messaging format to produce a second encoded message; and
A transceiver operatively coupled to the application layer Internet Protocol (IP) messaging encoder to wirelessly transmit the second encoded message on a wireless protocol.

12. An apparatus according to claim 11,
wherein said Short Messaging Service (SMS) encoder comprises a decoding capability; and
wherein said application layer Internet Protocol (IP) messaging encoder comprises a decoding capability.

13. An apparatus according to claim 11, wherein said application layer Internet Protocol (IP) messaging encoder further comprises a capability to encapsulate messages encoded by said SMS encoder.

14. An apparatus according to claim 11, wherein said application layer Internet Protocol (IP) messaging encoder comprises a signaling message encoder.

15. An apparatus according to claim 14, wherein said signaling message encoder comprises a Session Initiation Protocol (SIP) encoder to encode the first encoded message into a Session Initiation Protocol (SIP) signaling format to produce the second encoded message.

16. An apparatus for receiving encoded messages comprising:
a transceiver gateway, said transceiver further comprising an application layer Internet Protocol (IP) messaging decoder capable of decoding an application layer Internet Protocol (IP) message and producing a Short Messaging Service (SMS) encoded message; and
a server operatively coupled to receive the Short Messaging Service (SMS) message from the transceiver gateway, said server further comprising a Short Message decoder capable of decoding the Short Messaging Service (SMS) encoded message and producing an original text message.

17. An apparatus according to claim 16, wherein said transceiver gateway further comprises a capability of delivering said SMS encoded message to said server after said application layer Internet Protocol (IP) encoded message is decoded.

18. A apparatus according to claim 16, wherein application layer Internet Protocol (IP) messaging decoder is chosen from the group consisting of (a) a Session Initiation Protocol (SIP) format decoder, (b) a Media Gateway Control Protocol (MGCP) format decoder (H.248), and (c) an H.323 format decoder.

19. An apparatus according to claim 16, wherein said application layer Internet Protocol (IP) messaging decoder comprises a signaling message decoder.

20. An apparatus according to claim 19, wherein said signaling message decoder comprises a Session Initiation Protocol (SIP) decoder to decode the first encoded message of a Session Initiation Protocol (SIP) signaling message format to produce the second encoded message.
